(19) United States
(12) Patent Application Publication
(10) Pub. No.: US 2007/0186176 A1
(43) Pub. Date: Aug. 9, 2007

(54) System and method for window tab organization

(75) Inventor: Hector Stuart Godley, Hsinchu (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 11/351,051

(22) Filed: Feb. 9, 2006

(51) Int. Cl. G06F 9/00

(52) U.S. Cl. 715/764; 715/779; 715/810; 715/835

(57) ABSTRACT

A method, computer-readable medium and data processing system for associating application programs with user tasks is provided. A graphical object associated with an application program is selected. The graphical object is associated with a task identifier. A representation of the graphical object is then displayed with the task identifier.

### BACKGROUND

Contemporary computer systems allow a user to multi-task by allowing the user to quickly alternate between open applications. For example, on a computer system running a windowing operating system, such as a Windows operating system manufactured by Microsoft Corporation of Redmond, Wash., numerous applications may be concurrently opened that are each displayed through a respective “window” assigned to the application. As is commonly known, a window is a configurable viewing area provided on a display screen of a computer system that allows multiple viewing areas as part of a graphical user interface.

The application windows are managed by a window manager that may be integrated with the windowing-operating system. For example, the window manager keeps track of where each window is to be located in the display screen if the window is currently hidden or otherwise obscured by other windows that are in the foreground of the display screen. Contemporary windowing operating systems provide a graphical reference item, referred to herein as a task bar, that features selectable icons or window tabs that are each associated with one of the application windows. In this manner, a user may select a tab that corresponds with a window and that particular window is then displayed in the user interface foreground.

Many users often open numerous applications. Consequently, the task bar for displaying window tabs becomes crowded as the number of open applications increases. The task bar may become so densely populated with window tabs that a user may have difficulty discerning which window tab is associated with a particular window application. For example, task bars may include a label on a window tab that provides an identification of the application to which the widow tab is associated. As the number of open applications is increased, the window tabs in the task bar may be shrunk. As such, the label or other identifier on a window tab may become visually indistinct.

Moreover, a user may alternate between various tasks that each requires the user to use one or more different applications. For example, a user may alternate between working on a task that requires the use of various graphical applications, such as a slide presentation application, a computer aided drafting application, and a multi-media development application, and another task such as preparation of a document that requires use of a word processing application, an Internet browser, and an application for creating platform independent documents. In this situation, the window tabs of applications of different tasks are often intermixed on the user interface task bar. As such, a user may spend a considerable amount of time locating the appropriate window tabs each time the user alternates between tasks or between applications used for a common task.

### BRIEF DESCRIPTION OF THE DRAWINGS

Aspects of the present disclosure are best understood from the following detailed description when read with the accompanying figures, in which:

FIG. 1 is a diagram of an embodiment of a computer system in which window tabs may be organized according to tasks;

FIG. 2 is a simplified block diagram of an embodiment of a computer system that may be configured to implement window tab organization functionality;

FIG. 3 is a diagrammatical representation of an embodiment of a graphical user interface provided by a windowing operating system;

FIG. 4 is a simplified diagram of an embodiment of a software configuration that facilitates window tab organization;

FIG. 5 is a diagrammatical representation of an embodiment of a task bar featuring tab organizer functionality;

FIG. 6 is a diagrammatical representation of an embodiment of a task bar featuring tab organizer functionality after associating window tabs with a task identifier;

FIG. 7 is a diagrammatical representation of an embodiment of the task bar shown in FIG. 6 after a second selection of a sort command;

FIG. 8 is a diagrammatical representation of an embodiment of a user interface featuring saved task bar sub-panel object icons that may be selected for opening of saved task bar sub-panel data;

FIG. 9 is a diagrammatical representation of an embodiment of a user interface that facilitates association of applications to user tasks; and

FIG. 10 is a flowchart of an embodiment of window tab organizer processing for organizing application programs with user task identifiers.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

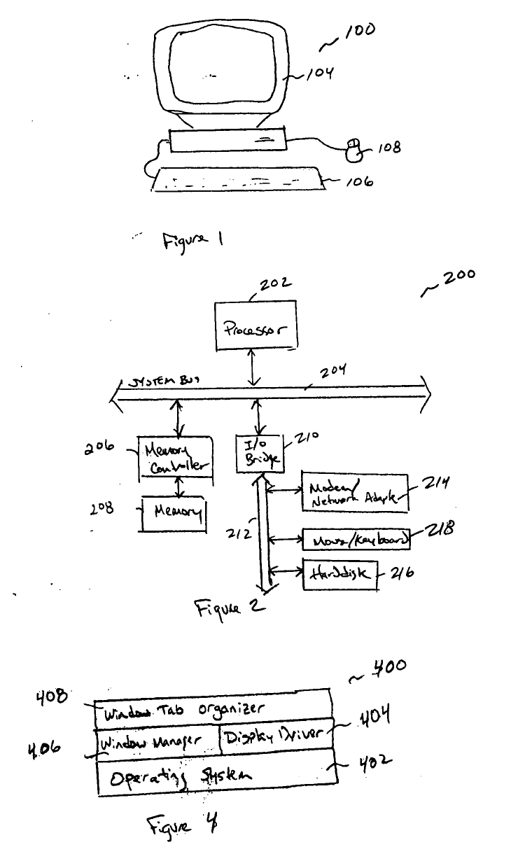

With reference now to the figures and in particular with reference to FIG. 1, a diagram of a computer system 100 in which window tabs may be organized according to tasks is shown. Computer system 100 may include a video display device or monitor 104 for visual display of system output, and various input devices, such as a keyboard 106 and a mouse 108. Preferably, computer system 100 runs a windowing operating system that provides a graphical user interface on display device 104. The graphical user interface may be implemented by system software residing in a computer readable media in operation within computer system 100 and may be stored locally within computer system 100. Alternatively, computer system 100 may be provided with a network interface, and the system software may be obtained by computer system 100 by way of network communications.

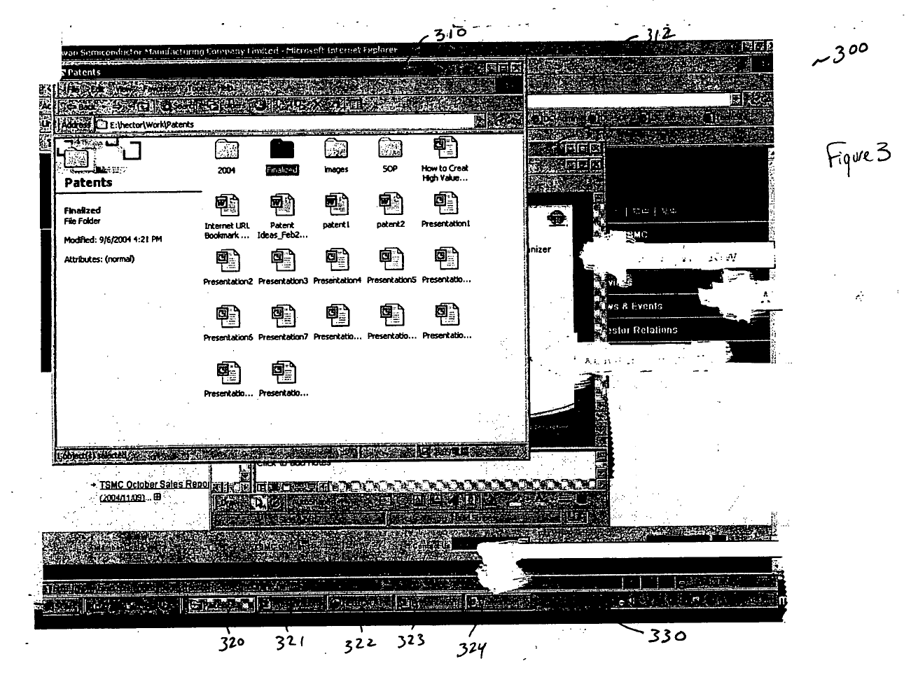

FIG. 2 is a simplified block diagram of a computer system 200, such as computer system 100 shown in FIG. 1, that may be configured to implement window tab organization functionality. Computer system 200 includes a processor 202 interconnected with a system bus 204. System bus 204 provides couplings to subsystems and components of computer system 200. A memory controller 206 interconnected with a system memory 208 provides a communicative coupling between memory 208 and processor 202. Memory 208 may store executable instructions that provide window tab organization functionality as described more fully below. An input/output (I/O) bridge 210 may be connected with system bus 204, and one or more input/output devices may be connected with an I/O bus 212. For example, a hard disk 216 may provide non-volatile storage, and a modem or network adapter 214 may provide a communication interface that facilitates communication exchanges between computer system 200 and one or more data resources. Additionally, user input devices, such as a mouse/keyboard 218, that facilitate user input to computer system 200 may be coupled with I/O bus 212. The configuration of computer system 200 is illustrative and is chosen only to facilitate an understanding of embodiments described herein.

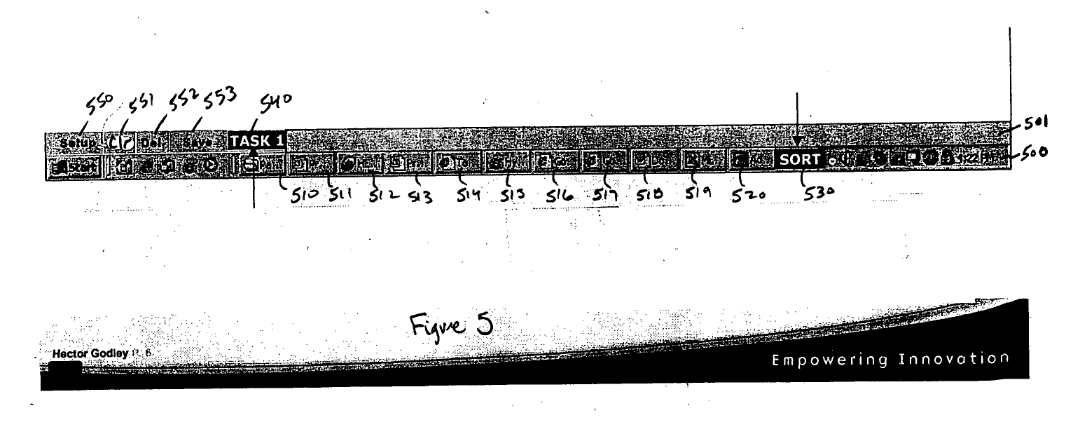

FIG. 3 is a diagram of an embodiment of a user interface 300 provided by a windowing operating system. User interface 300 includes various application windows 310-312. Each application window 310-312 encompasses a visual output of a respective application. Application windows 310-312 may be partially overlaid within user interface 300. The window of an active application may be displayed in the foreground if other windows are currently displayed within the user interface. For example, widow 310 is displayed in the foreground and is thus the presently selected window.

User interface 300 includes a task bar 330 that includes various window tabs 320-324. Window tabs 320-324 are each associated with a respective application window of an open application. For example, windows 310-312 may be associated with respective window tabs 320, 321, and 324. Selection of a window tab, for example by performing a mouse click thereon, may result in an associated application window being displayed in the foreground of user interface 300. For example, selection of window tab 324 associated with application window 312 may result in a reconfiguration and refresh of user interface 300 such that window 312 is displayed in the foreground of the display.

Window tabs 320-324 may include labels, such as a text label and/or a graphical label, that provides a visual indication of the associated application window. For example, window tab 324 may include an icon that is associated with the application assigned to application window 312. Thus, the user may bring application window 312 to the foreground by simply viewing window tabs 320-324 and selecting window tab 324 upon recognition of the icon associated with the desired application window.

As the number of open applications increases, the number of window tabs 320-324 displayed in task bar 330 likewise increases in a corresponding manner. The ability of a user to easily identify a window tab of an application when task bar 330 is densely populated with window tabs is diminished as the number of window tabs displayed in task bar 330 increases. Moreover, a user may alternate between various tasks that each requires the user to use one or more different applications. In this situation, the user may spend a considerable amount of time locating the window tabs of applications required for performing a particular task because the window tabs of all open applications may be intermixed within the task bar.

In accordance with embodiments described herein, applications may be associated with tasks by way of visual entities displayed in the user interface. In this manner, a user can sort applications based on a particular task to be performed. Particularly, embodiments described herein provide mechanisms for associating window tabs to a task identifier, and displaying window tabs of a particular task within a common region of a user interface.

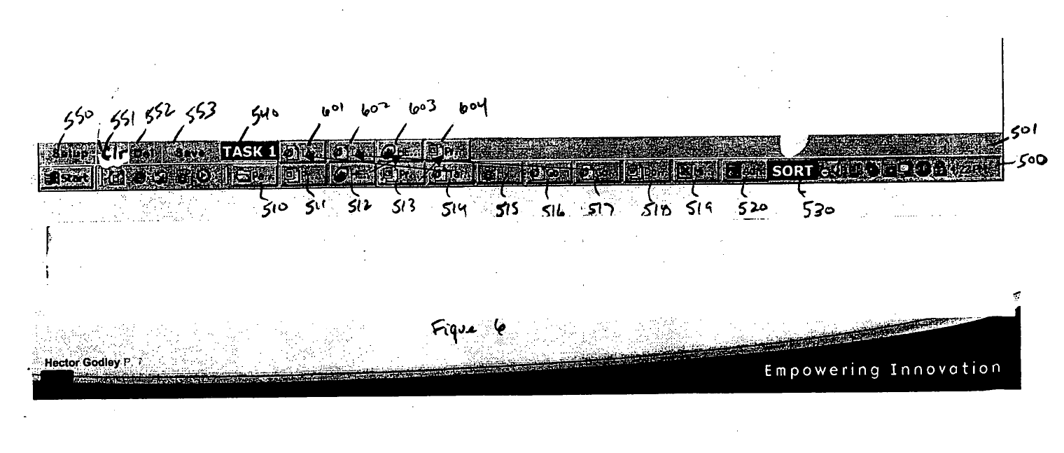

FIG. 4 is a simplified diagram of an embodiment of a software configuration 400 that facilitates window tab organization. Software configuration 400 comprises sets of computer-executable instructions or code that may be fetched from a memory and executed by a processing unit of a data processing system, such as computer system 200 shown in FIG. 2.

Software configuration 400 may include an operating system 402, such as a Windows operating system manufactured by Microsoft Corporation of Redmond, Wash., an OS/2 operating system manufactured by International Business Machines Corporation of Armonk, N.Y., or the like. Software control 400 may include a display driver 404 for controlling a display device, such as display device 104 shown in FIG. 1. Display driver 404 may be implemented as part of the operating system kernel. A window manager 406 may be implemented as part of operating system 402 and manages application windows. For example, window manager 406 may maintain status information on the location of application windows within the user interface, the size of the application windows, and various other application widow status data. Additionally, window manager 406 or operating system 402 may provide a task bar and maintenance functionality thereof that includes window tabs each associated with an open application window. A window tab organizer application 408 provides organization functionality and display functions thereof for grouping and display of window tabs in association-with a task identifier. In accordance with embodiments described herein, organizer application 408 provides mechanisms for a user to organize window tabs into task groups, application portal groups, and/or desktop groups. Organizer application 408 provides for increased efficiency in sorting applications, desktops and tasks into software relational environments that facilitate improved convenience when selecting and opening existing application windows and when multi-tasking between multiple tasks or applications as described more fully hereinbelow.

FIG. 5 is a diagrammatical representation of an embodiment of a task bar 500 featuring tab organizer functionality. Task bar 500 is displayed within a user interface of a computer running a windowing operating system. Task bar 500 includes various window tabs 510-520 each associated with a respective application. Selection of a window tab results in window manager 406 refreshing the user interface such that the application associated with the selected window tab is brought to the display foreground.

Window tab organizer application 408 includes logic for displaying a sort command 530 within task bar 500 that facilitates the organization of window tabs with relevance or association to a particular user task. In response to selection of sort command 530, for example by way of a user performing a mouse click thereon, window tab organizer application 408 invokes one or more methods, subroutines, or other logic that produce a task bar sub-panel 501 that may be displayed adjacent to task bar 500. Task bar sub-panel 501 may include one or more controls, such as a setup control 550, a clear control 551, a delete control 552, and a save control 553. Additionally, task bar sub-panel 501 may include a task identifier 540 displayed as a graphical object or other visual entity.

Task bar sub-panel 501 provides an associative entity in which representations of window tabs associated with applications used for performing a particular task may be collectively displayed in mutual association. Task bar sub-panel 501 does not initially include any window tabs in association therewith. The user may group window tabs into a task association by, for example, performing a drag-and-drop procedure from task bar 500 to task bar sub-panel 501 on one or more window tabs 510-520 that may be used to perform a particular task. Task identifier 540 may be edited by a user to provide a description of a task. A user may select task identifier 540, for example by performing a mouse click thereon, and enter text that describes a task for which the user desires to sort window tabs.

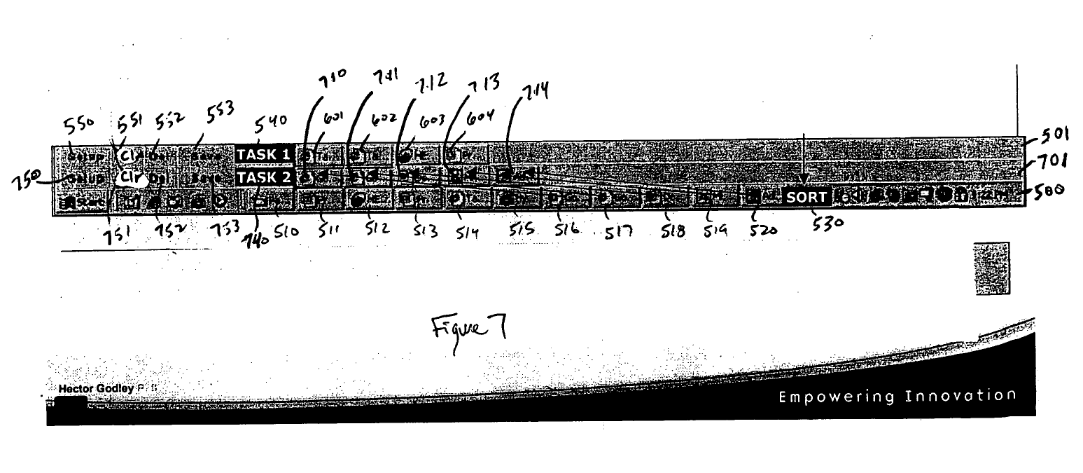

FIG. 6 is a diagrammatical representation of an embodiment of task bar 500 featuring tab organizer functionality after associating applications with a task identifier. For illustrative purposes, assume window tab 514 is first selected for association with a task identified by task identifier 540. The user may perform a drag-and-drop procedure by performing a mouse click on window tab 514 and dragging window tab 514 into task bar sub-panel 501. A window tab copy 601 of selected window tab 514 is then placed in task bar sub-panel 501. Window tab copy 601 is a representation of window tab 514 and is logically associated with window tab 514. For example, window tab copy 601 may be implemented in a manner similar to a quick link. Selection of window tab copy 601 results in the selection command being passed through to window tab 514 which window tab copy 601 represents. Likewise, window tabs 512-513 and 517 may be selected for association with the task identified by task identifier 540, and window tab copies are placed in task bar sub-panel 501 in response to dragging and dropping window tabs 512-513 and 517 into task bar subpanel 501. In the illustrative example, window tab 512 has an associated window tab copy 603, window tab 513 has an associated window tab copy 604, and window tab 517 has an associated window tab copy 602. A visual indication of application-to-task associations is thus provided by display of selected window tab copies in conjunction with a task identifier.

As mentioned above, task bar sub-panel 501 may include various controls that facilitate management and associations of window tabs with a particular task. Selection of setup control 550 may invoke one or more methods, subroutines, or other logic of window tab organizer application 408 that facilitates customization of tab organization functionality. For example, selection of setup control 550 may provide a dialog or other command entry interface for a user to customize task priorities, enable automatic launching of window tab organizer application 408, or specify other application configurations.

Selection of clear control 551 may invoke one or more methods, subroutines, or other logic of window tab organizer application 408 to clear window tab copies from the task bar sub-panel. One or more window tabs may then be selected and associated with the newly emptied task bar sub-panel by clicking and dragging window tabs to the task bar sub-panel.

Selection of delete control 552 may invoke one or more methods, subroutines, or other logic of window tab organizer application 408 to delete task bar sub-panel 501. Window tab organizer application 408 then refreshes the user interface, and task bar 500 will be displayed without task bar sub-panel 501.

Selection of save control 553 may invoke one or more methods, subroutines, or other logic of window tab organizer application 408 to save the task bar sub-panel with the associated window tab copies for future usage. For example, a task bar sub-panel object may be created by windows tab organizer application 408 that logically defines task bar sub-panel 501 including any window tab copies associated therewith. The task bar subpanel object is then saved, for example in a storage device, and may be later retrieved therefrom by window tab organizer application 408.

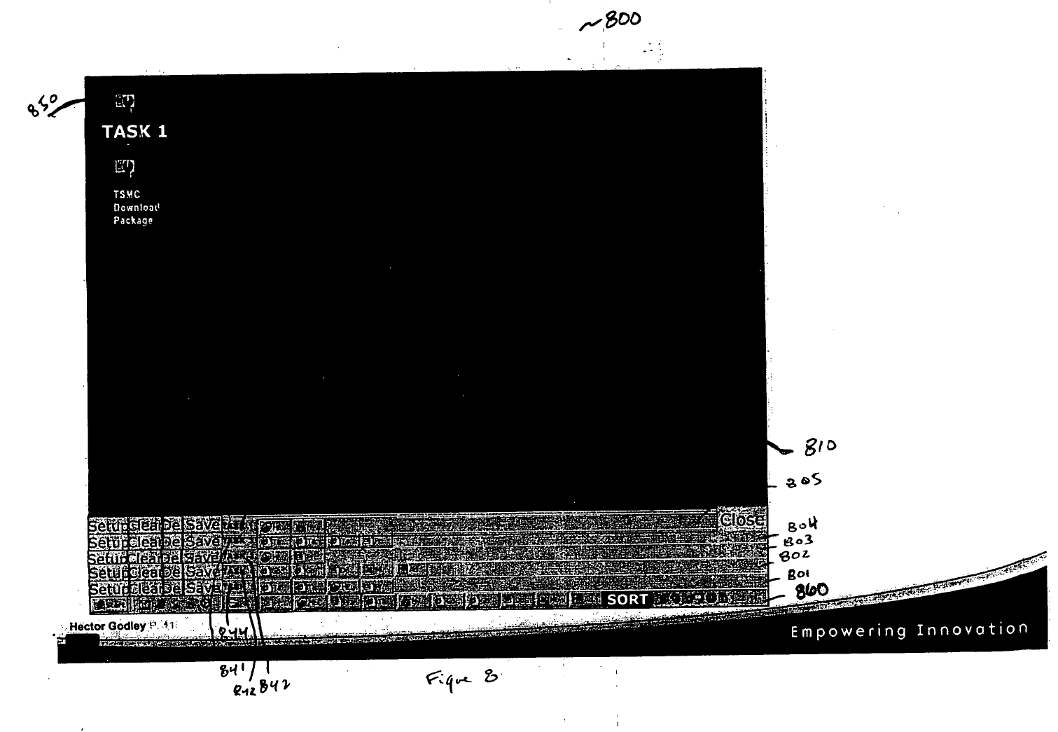

A user may at any time add additional task bar sub-panels by again selecting sort control 530. FIG. 7 is a diagrammatical representation of an embodiment of task bar 500 after a second selection of sort command 530. In the illustrative example, a new task bar sub-panel 701 has been added to task bar 500 in addition to the previously created task bar sub-panel 501. A number of window tab copies 710-714 have been added to task bar sub-panel 701 by selection and association of respective window tabs 516-520 with task bar sub-panel 701. In a similar manner to that described with reference to task bar sub-panel 501, task bar sub-panel 701 may include a setup control 750, a clear control 751, and delete control 752, and a save control 753.

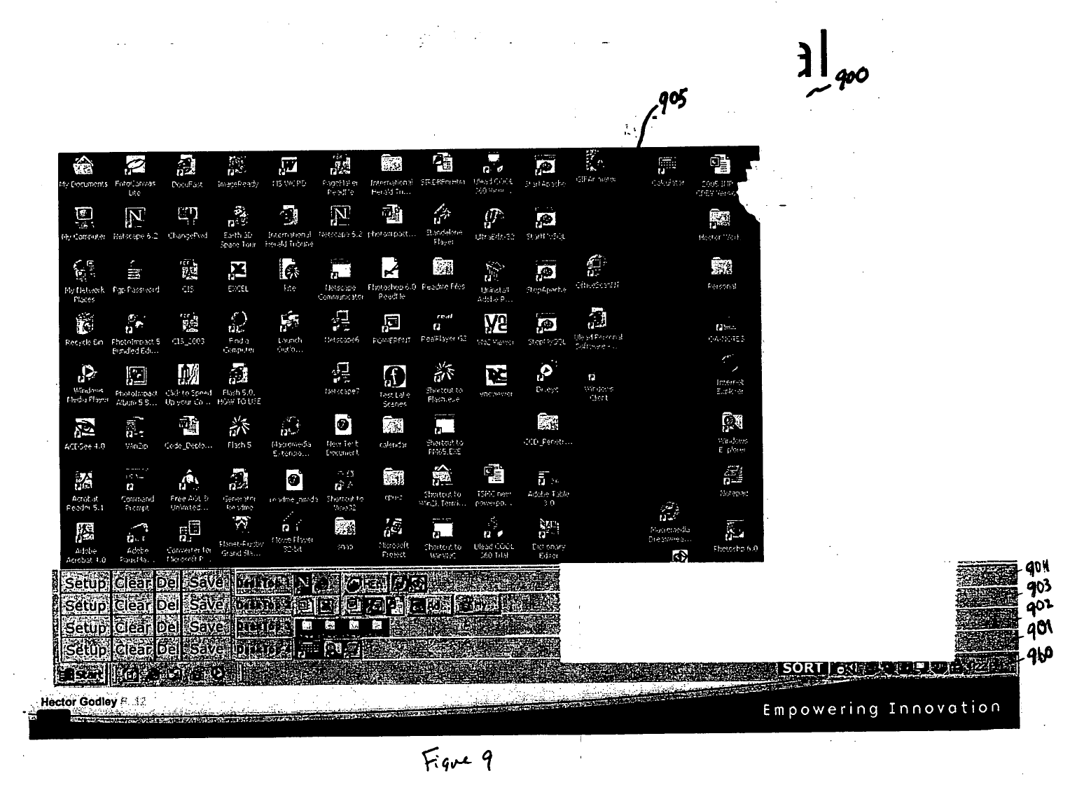

FIG. 8 is a diagrammatical representation of an embodiment of a user interface 800 featuring saved task bar sub-panel object icons that may be selected for opening of the saved task bar sub-panel data. User interface 800 may include a desktop 810 that includes a task bar 860. Task bar 860 may include one or more task bar sub-panels 801-805 that each may include window tab copies as described above with reference to FIG. 6. When a task bar sub-panel is saved, for example by selection of a save control within a task bar sub-panel, a task bar sub-panel object is created and a graphical representation thereof is displayed as an icon on desktop 810. In another embodiment, a task bar sub-panel may be saved by performing a drag operation on a task bar sub-panel. For example, task bar sub-panel 805 may be selected by performing a mouse click thereon and dragging task bar sub-panel 805 to desktop 810. Upon release of the mouse button, a task bar sub-panel object is created and saved, and a task bar subpanel icon 850 is created and displayed in desktop 810. Task bar sub-panel icon 850 may include a label or other identifier of the task bar sub-panel represented thereby. For example, task bar sub-panel icon 850 includes a label “TASK 1” and is representative of task bar sub-panel 805. The task bar sub-panel icon is saved on desktop 810 and may be selected at a later time, for example after the computer system is shutdown and later restarted. Responsive to selection of task bar sub-panel icon 850, the task bar sub-panel object is retrieved, and the window tab organizer application 408 generates a corresponding task bar sub-panel 805 corresponding to task bar sub-panel icon 850.

In accordance with another embodiment, user interface 800 facilitates grouping of multiple task bar subpanels. Multiple task bar subpanels may be selected, for example by performing a mouse click selection on multiple task bar subpanels. Selected task bar subpanels may then be saved by dragging the selected task bar subpanels to desktop 810. In the illustrative example, assume task bar subpanels 801-805 are selected and dragged to desktop 810. On release of the selected task bar subpanels 801-805 in desktop 810, a task bar subpanels object is created and saved, and a desktop icon 851 is created on desktop 810. The configuration of task bar subpanels 801-805 may then be reloaded at a later time, for example after system shutdown and a subsequent reboot, by selecting icon 851.

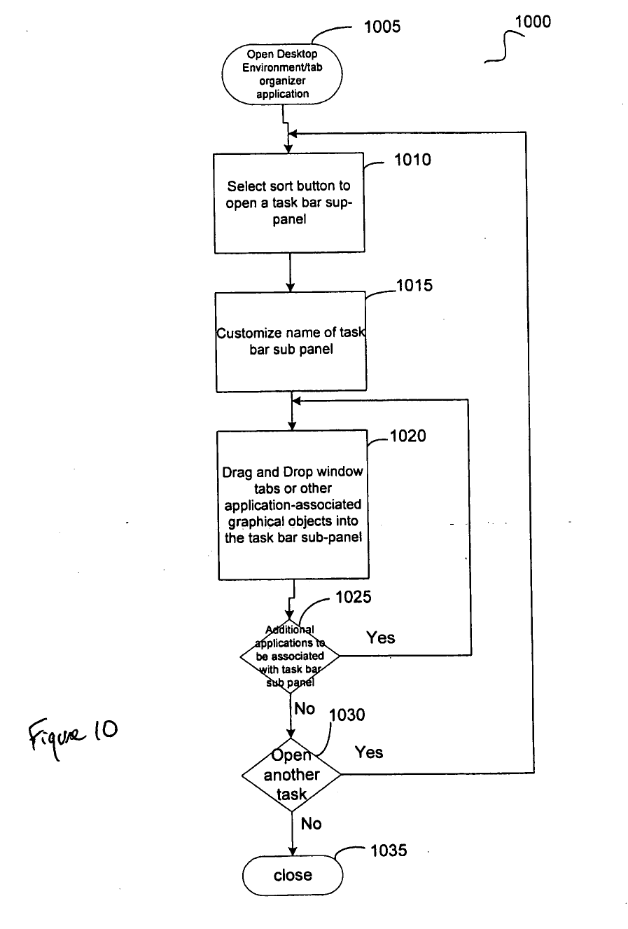

FIG. 9 is a diagrammatical representation of an embodiment of a user interface 900 that facilitates association of applications to user tasks. User interface 900 may include a desktop 905 on which one or more application icons, such as application icons 950-956, are displayed. Each application icon is associated with and representative of an application program. A task bar 960 may include one or more task bar subpanels 901-904 that facilitate association of applications to tasks. For example, a user may select an application icon, such as application icon 950, and drag the application icon into a task bar subpanel. An application icon or other graphical representation is then added to the task bar subpanel that is logically linked or otherwise associated with the selected application. In this manner, task bar subpanels provide an efficient mechanism for launching applications associated with a particular task.

FIG. 10 is a flowchart 1000 of an embodiment of window tab organizer processing for associating application programs with user task identifiers. Window tab organizer application 408 is invoked, for example upon boot of a system featuring a desktop and window tab organizer application 408 functionality (step 1005). A task bar subpanel is then opened, for example upon selection of sort command 530 shown in FIG. 5 (step 1010). The task status bar subpanel may then be customized by assigning a task name to the opened task bar subpanel (step 1015). A selection of one or more graphical objects associated with respective application program is received by window tab organizer application 408, and the selected graphical objects are associated with the task bar subpanel, for example by dragging and dropping the selected graphical objects on the task bar subpanel. (step 1020). The selected graphical objects may comprise one or more window tabs on the task bar, one or more desktop icons, or the like, that are selected by way of a user input supplied to mouse 108. Representations of the graphical objects that are logically linked to the graphical objects are displayed in the task bar subpanel in response to the association of the selected graphical objects and the task bar subpanel. A representation of a graphical object may be implemented as a copy of the graphical object and is logically linked with the graphical object. An evaluation may then be made to determine if additional applications are to be associated with the task bar subpanel (step 1025). If additional applications are to be associated with the task bar subpanel, organizer application 408 processing returns to step 1020 for selection of additional window tabs or other graphical objects and association thereof with a task bar subpanel. If it is determined that no additional applications are to be associated with the task bar subpanel, organizer application 408 may then proceed to determine if another task is to be opened (step 1030). If another task is to be opened, organizer application 408 processing may return to step 1010 for selection of the sort command to open a new task bar subpanel. Alternatively, if no additional tasks are to be opened, the window tab organizer application 408 processing cycle may then end (step 1035).

As described, embodiments provide mechanisms for associating application programs with user tasks. Window tabs of application windows may be associated with a visual task identifier. Copies of window tabs are displayed within a task bar subpanel having a task identifiers. A user is then easily able to identify and select one or more applications used for a particular task.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A method of associating application programs with user tasks, comprising:
selecting a graphical object associated with an application program;
associating the graphical object with a task identifier; and
displaying a representation of the graphical object with the task identifier.

2. The method of claim 1, wherein selecting the graphical object comprises selecting a window tab in a task bar displayed in a user interface.

3. The method of claim 1, wherein associating the graphical object comprises dragging the graphical object to a subpanel of a task bar, and wherein the subpanel includes the task identifier.

4. The method of claim 1, wherein displaying the representation comprises displaying a copy of the graphical object that is logically linked with the graphical object.

5. The method of claim 1, wherein selecting a graphical object comprises selecting a desktop icon that is logically associated with an executable of the application program.

6. The method of claim 1, further comprising repeating the selecting, associating, and displaying steps for each of a plurality of other graphical objects each associated with a respective application program.

7. The method of claim 1, further comprising:
selecting the representation; and
displaying a window of the application program in the foreground of a user interface.

8. A computer-readable medium having computer-executable instructions for execution by a processing system, the computer-executable instructions for performing a method of associating application programs with user tasks, comprising:
instructions that receive a selection of a graphical object associated with an application program;
instructions that associate the graphical object with a task identifier; and
instructions that display a representation of the graphical object with the task identifier.

9. The computer-readable medium of claim 8, wherein the instructions that receive selection of the graphical object comprise instructions that receive an input of selection of a window tab in a task bar displayed in a user interface.

10. The computer-readable medium of claim 8, wherein the instructions that associate the graphical object comprise instructions for dragging the graphical object to a subpanel of a task bar, and wherein the subpanel includes the task identifier.

11. The computer-readable medium of claim 8, wherein the instructions that display the representation comprises instructions that display a copy of the graphical object that is logically linked with the graphical object.

12. The computer-readable medium of claim 8, wherein the instructions that receive a selection of the graphical object comprise instructions that receive a selection of a desktop icon that is logically associated with an executable of the application program.

13. The computer-readable medium of claim 8, further comprising instructions for repeating the receiving, associating, and displaying steps for each of a plurality of other graphical objects each associated with a respective application program.

14. The computer-readable medium of claim 8, further comprising:
instructions the receive a selection of the representation; and
instructions that display a window of the application program in the foreground of a user interface.

15. A data processing system for associating application programs with user tasks, comprising:
a memory that contains a display driver, an organizer application, and the application programs as sets of instructions; and
a processing unit that, responsive to execution of the sets of instructions, receives a selection of a graphical object associated with an application program, associates the graphical object with a task identifier, and wherein the display driver produces a representation of the graphical object with the task identifier.

16. The data processing system of claim 15, further comprising a mouse, wherein the selection comprises a mouse click on a window tab in a task bar displayed in a user interface.

17. The data processing system of claim 16, wherein the processing unit associates the graphical object in response to a mouse input comprising a drag operation on the graphical object to a subpanel of a task bar, and wherein the subpanel includes the task identifier.

18. The data processing system of claim 15, further comprising a mouse, wherein the selection comprises a mouse click on a desktop icon that is logically associated with an executable of the application program.

19. The data processing system of claim 15, wherein the representation comprises a copy of the graphical object that is logically linked with the graphical object.

20. The data processing system of claim 15, wherein the display driver, responsive to a selection of the representation, produces a display of a window of the application program in a foreground of a user interface.
